(19) United States
(12) Patent Application Publication
(10) Pub. No.: US 2005/0047887 A1
(43) Pub. Date: Mar. 3, 2005

(54) Vehicle restraint system

(76) Inventor: Mark Kenny, Jensen Beach, FL (US)

Correspondence Address: TANGENT LAW GROUP, 1201 PENNSYLVANIA AVE, WASHINGTON, DC, 20004, US

(21) Appl. No.: 10/924,913

(22) Filed: Aug. 25, 2004

Related U.S. Application Data
(60) Provisional application No. 60/481,290, filed on Aug. 25, 2003.

(51) Int. Cl. B60P 3/06

(52) U.S. Cl. 410/30

(57) ABSTRACT

A method and a system for restraining a vehicle to a transport, the system having a first portion and a second portion rotatably coupled to the first portion and engaging a wheel of the vehicle. A locking mechanism is provided such that when the first portion is engaged by the wheel it rotates into the second portion and the locking mechanism is engaged and securely restrains the vehicle to the transport.

### CROSS-REFERENCE TO RELATED APPLICATIONS

This application claims the priority of U.S. provisional patent application 60/481,290, filed Aug. 25, 2003, which is incorporated herein by reference.

### FIELD OF THE INVENTION

The instant invention is directed generally to a vehicle restraint system for storage or mounting in or on a vehicle carrier to restrain a vehicle during transport. More specifically, the invention is directed to a restraint system for holding down lawn maintenance vehicles on a trailer.

### BACKGROUND OF THE INVENTION

A significant problem exists for people who need to transport vehicles for their job or hobby. This problem of restraining vehicles during transit or storage is widespread and varying, affecting many occupations and hobbies and involving vehicles such as all terrain vehicles, lawn maintenance equipment, landscaping equipment, golf carts, or for restraining vehicles in storage, for example, in tethering airplanes. Similarly, transport of motor vehicles, motorcycles, and the like on car carriers and other carriers suffer from similar problems.

Safely transporting vehicles and equipment is an especially persistent problem in the landscaping industry, where securing lawn equipment during transport to and from the job site is an at least once a day daily chore. These problems are particularly acute for the typical, large, flat trailer rig used to transport the tools of the trade. The movement of the trailer over rough terrain can be an expensive proposition for a landscaper. Unsecured lawn tractors, zero-turn mowers, and other expensive lawn maintenance vehicles can be damaged when jolted about on the trailer. Moreover, the jolting of the larger equipment can impact and destroy the smaller equipment typically stored in the trailer as well.

In addition to the cost in damaged equipment, existing systems to restrain the equipment during transport are inconvenient to implement and potentially unsafe. More and more the various state departments of transportation are making it mandatory to have all equipment secured to the trailer. On a Federal level, the U.S. Department of Transportation (IJSDOT) through the Federal Motor Carrier Safety Administration (FMCSA) has promulgated rules and regulations regarding cargo restraint systems. These regulations are available at from the FMCSA and are enumerated as FMCSR section 393.102 (see htt ://www.fmcsa.dot.gov/rulesregs/fmcsr/regs/393.102.htm) and available in the publication “Driver's Handbook on Cargo Securement: A Guide to the North American Cargo Securement Standard”.

In short, the provisions provide specific requirements for restraining loads under both acceleration and deceleration, separately, in five separate axis of movement relative to the travel of the load with respect to the vehicle. To summarize these requirements, the systems must be able to provide support for the rated load in 0.8 g acceleration/deceleration in the forward direction, 0.5 g acceleration/deceleration in the rearward and lateral directions and 0.2 g acceleration/deceleration in an upward direction, as seen in accompanying FIG. 1A. This leads to a need for significant testing and development of secure and safe restraining systems. To date, few if any designs have been promulgated that effectively and efficiently allow for quick securement of vehicles for transport. The existing systems using belts, chains and strapping widely used in the trucking industry have often been pressed into use for hobbyists and vehicle transport for commercial service situations, like landscaping.

These systems suffer significantly from over complexity and a multitude of parts that can go missing or break after repeated application. This is especially true of the use of existing systems in the landscaping industry. Employees loading and unloading equipment many times a day, often in an attempt to save time, will tend to skip the now often necessary step of tying down equipment, especially on short trips. This might result in fines and traffic violations that may increase insurance premiums for the employer.

Moreover, in all of these commercially available methods of restraining vehicles for transport, the operator is required to make direct contact with the unsecured machine or vehicle to secure it. During this operation, the vehicle could roll or move and cause severe bodily injury. Heavy wheeled equipment can also be very difficult to bind and very dangerous due to size of the vehicle and the size of the chains or straps and the tension necessary to secure the heavy equipment. This danger is magnified when the trailer is being loaded on a grade or hill, as the potential for rolling or even a rollover when loading is significantly increased. A need exists for an improved wheel restraint that both reliably secures vehicle wheels to transports and is easily and safely employed.

Several attempts have been made at providing wheel tie downs and locking mechanisms, but none has successfully addressed the requirements outlined above. These vary from the simple restraints like that shown in U.S. Pat. Nos. 5,160,223 or 4,875,813 showing a wheel chock or like those shown at www.category.org/browse_{—}Hlt48040610/_Hlt48040610 universal/897508/_Hlt48040600_Hlt48040600 index_page_no_{—}2.html, which comprise nothing more than a Y-bar yoke and latching bar, to complex webbing devices and ratcheting mechanisms. Some examples of these complex webbing and ratcheting devices include U.S. Pat. No. 5,011,347 to Bullock, U.S. Pat. No. 5,294,221 to Eller et al., U.S. Pat. No. 5,540,540 to Peterson U.S. Pat. No. 5,586,849 to Kissel et al. and U.S. Pat. No. 6,139,231 to Kissel. These devices are overly complex and require a significant amount of effort to secure the wheel in the webbing and then additional effort to secure the wheel, effort that costs time and money. Also, as mentioned above, the webbing and the additional loose parts are prone to separation from the system, and, once lost, the system is useless.

Additional devices exist that include bars or other forms of solid holdowns, for example U.S. Pat. No. 5,593,260 to Zimmerman and U.S. Pat. No. 5,173,018 to Kissel et al. These devices are cumbersome and time-consuming to activate and even more difficult to quickly release. These devices also remain susceptible to the lose of parts that, once lost, may render the system useless.

In U.S. Pat. No. 2,991,894 to Walker a spare tire holder for holding a spare tire in a vehicle and deploying it in a controlled manner is shown. The spare tire holder, though sufficient to retain a spare tire, is incapable of restraining a vehicle, much less meeting the FMCSA regulations. Additionally, the system uses a control mechanism to slow the motion of the wheel in and out of the mechanism. So, besides not securing a vehicle as originally designed, even it were modified it would not permit the free rotation of the members and therefore would not be capable of quick and safe engagement and disengagement of a vehicle for secure transport.

Similarly, in European Patent number EP0319013, a spare tire holder is shown. The spare tire is held in place and can be maneuvered with a swivel lever from its closed position. Again, the spare tire holder is not sufficient to restrain a vehicle. Moreover, it is similarly not able to freely rotate and accept a tire that is attached to a vehicle.

Various stands have also been proposed for transport of motorcycles and for upright storage of motorcycles. For example, U.S. Pat. No. 3,785,517 to Brajkovich shows a stand for transport of a motorcycle. Though the design is for transport of a vehicle and provides for ease of use, the design fails to provide for securment of the vehicle in the upward direction. This fails to meet the safety standards. Similarly, in U.S. Pat. No. 5,145,308 to Vaughn et al. a device for towing a motorcycle by its front wheel is shown.

Again, though the system does provide for retention of the vehicle during transport and secures the front wheel against forward, rearward, and lateral directions, it fails to provide for securement of the vehicle against upward forces. These systems are not sufficient to meet the FMCSA standards

U.S. Pat. Nos. 6,241,104 to Kraus, 5,988,402 to Mayfield, 5,735,410 to Kallstromm, and 6,640,979 to Mayfield are directed to stabilizing stands for motorcycles and similar vehicles that require assistance to remain upright while in storage. The systems do provide for a stands that can be manipulated by the motion of the vehicle, in this case a motorcycle, as it enters the stand and provide support to stand the vehicle up.

However, none of these systems alone can provide adequate support and securement of a vehicle during transport, see for instance the trailer instructions advertised with the production model of the Mayfield '410 and Mayfield '979 devices at http://www.baxleycompanies.com/LAChock.html, which states “Once in, you can get off the bike and secure the bike with straps without someone else having to hold the bike up for you.” These stands fail to contact the tire of the vehicle in a manner sufficient to restrain the vehicle in all the axis of motion specified in the FMCSA guidelines without additional strapping and are not capable of withstanding the required loads for safe transport without additional strapping. Simply put, they are not sufficiently designed alone to act as vehicle restraint systems in a transport environment.

Further devices exist that act to guide or align vehicles when the vehicles are being stored or need to be positioned in a specific way. For example, the Rite-Hite Corporation has several patents worldwide, including U.S. Pat. No. 5,762,459, PCT International Application PCT/US96/18863, and European Patent EP0905066, that cover a system to assist in halting vehicles, particularly delivery trucks, from moving beyond safe points when backing into a loading dock. The system provides a track with various positions for locking a locking arm in position. The locking arm allows the system to act as a chock for various sizes of delivery truck. However, this system is not designed to restrain the vehicle, but instead simply retard its forward or rearward motion by chocking it and act as an indicator for the operator that a specified position has been reached. As such, it does not provide the portability and security necessary to restrain a vehicle from release during transport or properly store the vehicle.

Several other devices have been developed to restrain a wheel chair while the operator is in transit. These include U.S. Pat. No. 4,389,056 to Tenniswood, U.S. Pat. Nos. 6,231,283 to Stowers, 4,475,762 to DeLong et al., and US. Pat. No. 4,019,752 to Leon et al. These devices primarily involve complex systems utilizing straight bars and pins accessible to the occupant of the chair. Although designed for providing secure restraint during transport, the complexity and cost of these systems makes them impractical for use in a utilitarian role to transport vehicles. None of these devices has found commercial success in rapid, safe securement of vehicles for transport, such as lawn equipment or hobbyist vehicles like ATVs and motorcycles.

As such, a need exists for a solid, dependable, easily deployable vehicle restraint for mounting in or on a vehicle carrier. The restraint should be easily engaged and disengaged, easy to maintain, inexpensive to produce, require few if any separable components, and require a minimum of tools for installation. The restraint should also comport with the FMCSA and similar restraint requirements promulgated by appropriate authorities.

### SUMMARY OF THE INVENTION

An object of the invention is to eliminate the need for strap or chain binders that are time consuming to install and if not fastened properly can slip or loosen up.

A further object of the invention is to avoid chain binders and straps that require additional parts that can become lost and avoid the dangers of manually tightening the chains or binders.

A still further object of the instant invention is to provide a wheel restraint that activates when the equipment makes with the device and secures the device.

Yet another advantage of instant invention is that the operator never needs to contact dangerous parts of the equipment or compromise their safety to secure equipment.

Another object of the invention is to provide a device that satisfies various state departments of transportation regulations for binding equipment to transports.

Yet another object of the instant invention it to provide a wheel restraint device that allows operators that are loading and unloading equipment many times a day to save time in securing the equipment.

A still further object of the invention is to provide a method and device that does not require direct contact with the machine or vehicle to safely secure equipment for transport.

Yet a further object of the invention is to provide a vehicle restraint system that meets or exceeds the FMCSA standards.

Reference is herein made to a wheel of a vehicle and restraining the wheel of a vehicle. The reference to a wheel can include, but is not limited to any combination of sub-components typically included in a wheel, including but not limited to a rim, a tire, a tube, or similar components on which a vehicle is supported or supported and propelled.

The invention includes a vehicle restraint system restraining a vehicle to a transport, having a first of an at least two body portions freely and rotatably coupled to a second portion of an at least two body portions and receiving a wheel of said vehicle, the second of the at least two body portions being coupled to said transport and a locking mechanism. The first body portion of the at least two body portions is engaged by the wheel of the vehicle to be restrained and the motion of the vehicle rotating the first body portion into the second body portion engages the locking mechanism to securely restrain the vehicle to the transport.

An at least one pivot point with an at least one pivot member therethrough, rotatably coupling the first body portion and the second body portion can be provided.

The at least one pivot point and the at least one pivot member can also be a first and second pivot point and a first and second pivot member. The first pivot member can be coupled to the second and first body portions at said first pivot point.

An at least one receiver portion can also be provided where the engagement of the locking mechanism moves the at least one receiver portion relative to the second body portion. The at least one receiver can also be coupled by first and second pivot members that pass through first and second pivot points. Each receiver can also have an at least one spring member, a slot with the first pivot member slideably disposed therein, and a notch extending from the slot and receiving the first pivot member where the pivot member is slidably disposed into the notch when the system is rotated to a closed position.

The first pivot member can be simultaneously slideably disposed in a frame channel in a frame portion of the second body portion. The first pivot member slides simultaneously in said slot and said frame channel and into the notch during an initial rotation of said second body portion. The first pivot member can also be pushed into the notch when the locking mechanism is engaged in a closed position and the first pivot member is held in the notch by the at least one spring member.

The first body member can rotate into the second body member and the second pivot member can rotate at the second hinge point. A locking plate can be disposed in the second body member. The locking plate can also be provided within the first body portion. The locking plate can be coupled to the second pivot member and rotate therewith.

The locking plate can be coupled to the second pivot member such that when the receiver is moved to the closed position the second pivot member rotates the locking plate up just above a lip of the first body portion.

An at least one release mechanism to release the vehicle restraint from the closed position can also be provided. The at least one release mechanism can engage and disengage an at least one spring member. The at least one receiver can be moved from a first position, with the first pivot member in a first position, moving with the motion of the first body member that moves the first pivot member down the slot and to a second position to engage the first pivot member in the notch then back to the first position with the completion of the rotation of the first body portion, the first pivot member being held in the notch.

The release mechanism can be operated without requiring use of an operators hands. The release mechanism can include a step plate that is depressed and releases the spring member which in turn allows the at first pivot member to freely move within the slot and channel to an open position. The vehicle movement can return the system to an open position after release.

Enclosure portions extending from the first portion and restraining the wheel can also be provided. The enclosure portions can include, for instance, a first enclosure side and second enclosure side portions of the first body portion, extending up from a curved bottom portion, the bottom, first side and second side portions extending around the circumference of the wheel of the vehicle. The enclosure portions can also include a third and fourth side enclosure portions extending from the second body portion. The enclosure portions can extend from the first portion to enclose between about 90 and about 270 degrees of the wheel when the first portion rotates into the second portion.

Likewise, the enclosure portions can also for example extend around between about fifty and ninety percent of the circumference of the wheel when the system is closed.

The enclosure portions and the first portion can be semi-circular. The first and second portions can be composed of at least one of steel, iron, aluminum, rubber, plastic, and composite.

The locking mechanism can be an at least one spring loaded pin that engages a corresponding detent in said second body portion. The at least one spring loaded pin can be pulled to release the second body portion and remove the vehicle from the vehicle restraint system. A locking plate can also be provided, the locking plate being coupled to the second pivot member such that when the first body portion is moved to the closed position the second pivot member rotates the locking plate up just above a lip of the first body portion.

The first body portion can include a frame portion. The frame portion can have an at least one mounting protrusion. The system can also include a mounting frame, the mounting frame being connected to the transport and releasably engaging the at least one mounting protrusion of the frame portion. The second body portion can also be a frame portion and a second rotatable body portion. The second rotatable body portion can be rotatably coupled to the frame portion and rotates in an opposite direction to said first body portion. The transport can be one of a transport vehicle, a trailer, a dolly, or a cart.

The system can restrain a rated load under acceleration or deceleration of at least 0.2 g in at least one of a forward, rearward, lateral, and upward direction relative to the motion of travel of the vehicle and transport. The system can restrain a rated load under acceleration or deceleration of at least 0.5 g in at least one of a forward, rearward, lateral, and upward direction relative to the motion of travel of the vehicle and transport. The system can be designed to restrains a rated load under acceleration or deceleration of at least 0.8 g in at least one of a forward, rearward, lateral, and upward direction relative to the motion of travel of the vehicle and transport. The rated load can be an at least 700 pounds.

The second body portion can include an at least one wheel stop, the at least one wheel stop engaging the wheel of the vehicle and aiding in securing the wheel when the system is closed and the lock mechanism engaged. The position of the at least one wheel stop on the second body portion can be adjustable.

The locking mechanism can be an at least two spring loaded pins coupled to and selectively securing said first body portion and said second rotatable body portion in a closed position. The at least two body portions can comprise only the first and second body portions. The at least two body portions can comprise three or more body portions.

The invention also includes a vehicle restraint system restraining a vehicle to a transport having a frame portion coupled to the transport, a first body portion rotatably coupled to and freely rotating with respect to the frame portion through the motion of the vehicle, a second body portion rotatably coupled and freely rotating with respect to said frame portion through the motion of the vehicle and a locking mechanism. The first portion can be engaged by the vehicle and the motion of the vehicle can rotate the first and second body portion into said frame portion, the locking mechanism being engaged to lock the first and second body portions into place by the rotational motion imparted by the vehicle and secure the vehicle to the transport.

The first and second body portion can be coupled at a common point of rotation to simultaneously transmit motion to both first and second body portions. The first and second body portions can be coupled by an at least one mechanical link to transmit simultaneous motion through both first and second body portions. The first and second body portion can also be coupled by a geared coupling mechanism that simultaneously transmits the motion of the first body portion to the second body portion.

The method of the invention includes a method of restraining a wheeled vehicle on a transport, comprising the steps of coupling a vehicle restraining system to said transport, propelling the wheeled vehicle onto the transport, guiding an at least one wheel of the wheeled vehicle into a first portion of a vehicle restraining system, rotating the first portion of the vehicle restraining system into a second portion of the vehicle restraining system, the second portion being coupled to the transport, and engaging a locking mechanism in the vehicle restraining system when the first portion of the vehicle restraining system is fully engaged with the second portion of the vehicle restraining system restraining the vehicle to the transport.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF DRAWINGS

Embodiments of the invention are explained in greater detail by way of the drawings, where the same reference numerals refer to the same features.

FIG. 1A shows the FMCSA guidelines for acceleration/deceleration in securement systems.

FIG. 1B shows an exemplary embodiment of the instant invention deployed on a transport and prepared to engage the wheel of a vehicle.

FIG. 1C shows a side view of an exemplary embodiment of the instant invention in an open position.

FIG. 2A shows a close up side view of the retainer portion of the locking mechanism of an exemplary embodiment in a closed position with the open position in shadow.

FIG. 2B shows a close up side view of the retainer portion and the locking plate of the locking mechanism of an exemplary embodiment in a closed position with the open position in shadow.

FIG. 3 shows a side view of an exemplary embodiment of the instant invention in a closed position.

FIG. 4 shows a further exemplary embodiment of the instant invention in an open position.

FIG. 5 shows a still further exemplary embodiment of the instant invention in an open position.

FIG. 6 shows yet another exemplary embodiment of the instant invention with a quick release mounting plate in an open position.

FIG. 7 shows yet another exemplary embodiment of the instant invention with a quick release mounting plate in a closed position.

### DETAILED DESCRIPTION

In the drawings depicted elements are not necessarily drawn to scale and alike and similar elements are designated by the same and similar reference numerals throughout the several figures. The exemplary embodiments and examples discussed herein are non-limiting examples.

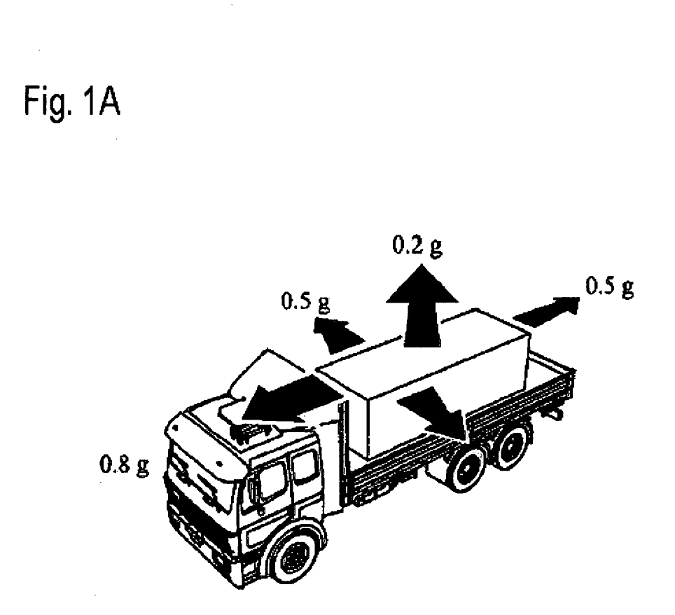

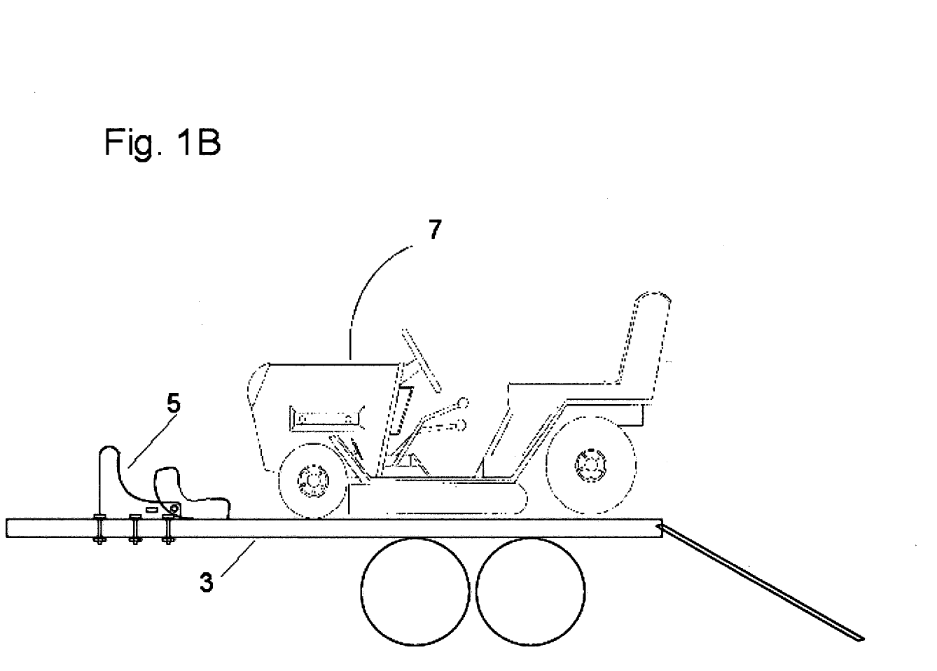

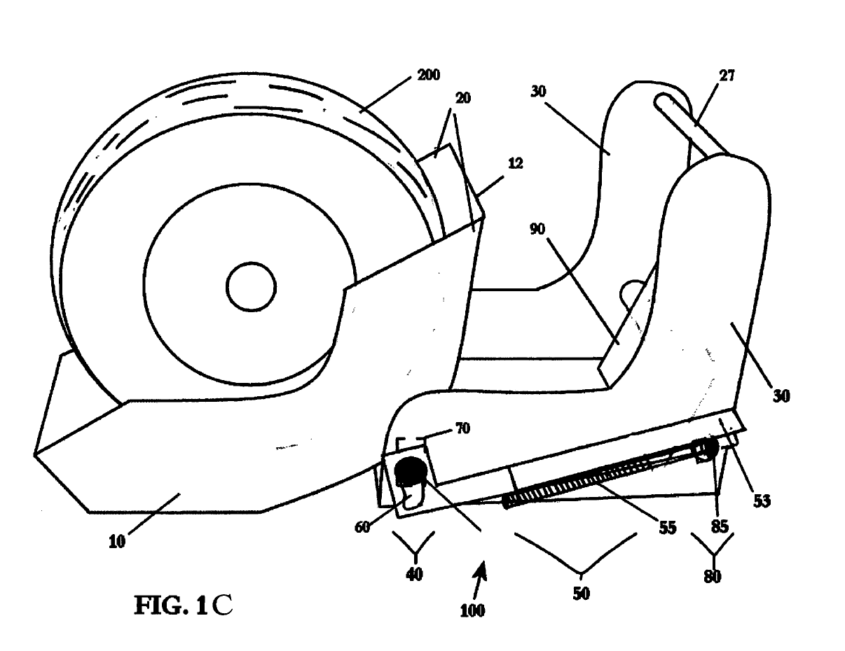

FIG. 1A shows the FMCSA guidelines for acceleration/deceleration in securement systems. As previously discussed, these safety guidelines require a securement system to restrain a rated load in acceleration and deceleration, separately, in five axes relative to the motion of the vehicle. These are 0.8 g of acceleration/deceleration in a forward direction, 0.5 g acceleration/deceleration in the rearward and lateral directions and 0.2 g acceleration/deceleration in an upward direction, as seen in FIG. 1A taken from the publication “Driver's Handbook on Cargo Securement: A Guide to the North American Cargo Securement Standard”.

FIG. 1B shows an exemplary embodiment of the instant invention deployed on a transport and prepared to engage the wheel of a vehicle. In the figure, a transport 3, which is for example, but is certainly not limited to, a trailer, is provided with an exemplary embodiment of the vehicle restraint system 5 and a vehicle 7, for example a lawn equipment vehicle, is driven toward the vehicle restraint system 5, which is in the open position and secured to the transport. The system can be secured by any means sufficient to meet the acceleration guidelines outlined in FIG. 1A, for instance with through bolts having sufficient tensile ratings for the load rating of the vehicle restraint system or through welding or other coupling devices or methods.

FIG. 1C shows a side view of an exemplary embodiment of the instant invention in the open position. The invention comprises a first or boot portion 10. The boot portion 10 is coupled to a second or frame portion 30. The boot portion 10 has enclosure sections 20 extending from and around it. In the exemplary embodiment, the boot portion 10, the frame portion 30, and enclosure portions 20 envelop the wheel 200. In the exemplary embodiment shown, the boot portion 10, the frame portion 30, and enclosure portions 20 may enclose between about 190 and about 270 degrees around the wheel 200 when closed. The boot portion 10 and its enclosure sections 20 are semi-circular in an exemplary embodiment. Alternatively, open frames or portions with bar ends in either or both the boot portion 10 and the frame portion 30 may replace the enclosure portions 20. A wheel stop 27 is provided in the frame portion 30. The wheel stop 27 both prevents further forward motion of the wheel 200 and helps restrain the wheel 200 from coming out of the instant invention. To accommodate a variety of wheel sizes and provide for accommodation of standard deviations in tire sizes, the wheel stop 27 may be adjustably mounted. To adjustably mount the wheel stop 27 at least one of a series of wholes, a slot, or similar mechanisms can be placed on or in the frame portion 30 or other appropriate component to allow the operator to adjust the points of contact of the system with the wheel of the vehicle.

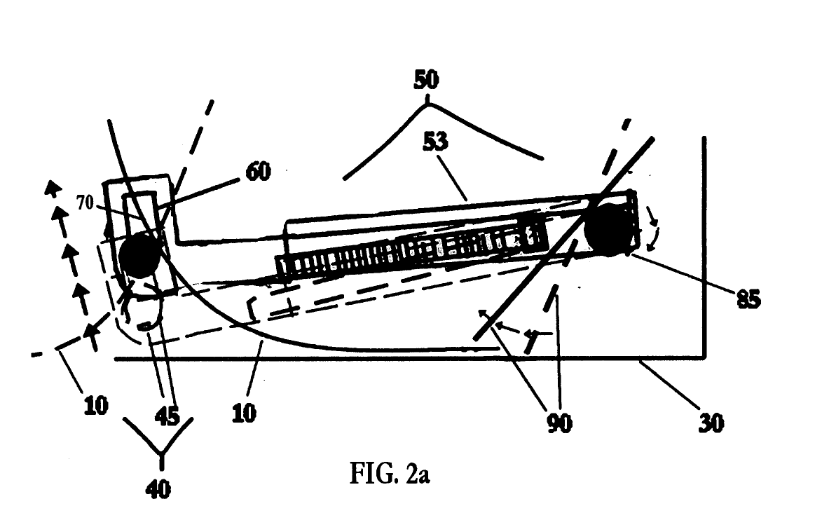

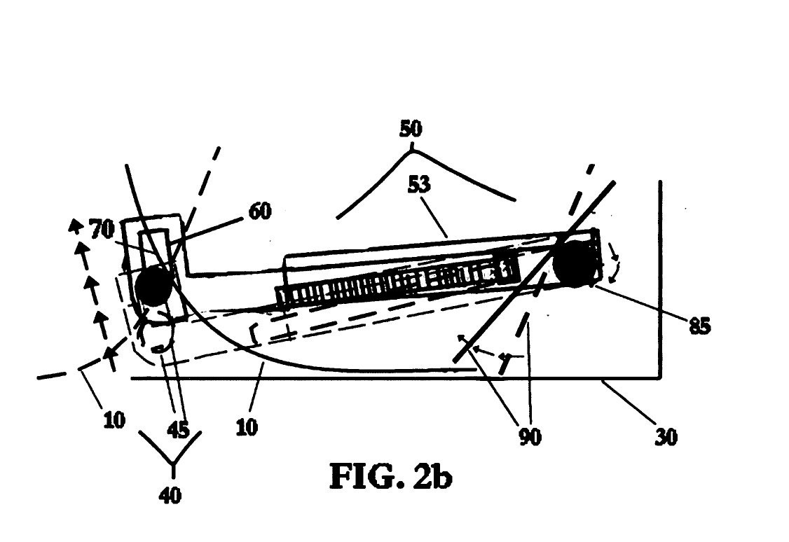

The boot portion 10 and frame portion 30 are, for instance, coupled at a pivot or hinge point 40. The hinge point 40 provides for rotational movement of the boot portion 10 relative to the frame portion 30. A first pivot member 45 passes through the pivot point 40. The boot portion 10 rotates into the frame portion 30 when closing. This rotation is about the pivot point 40 and is imparted by the motion of the vehicle. A receiver 50 is provided as part of a locking mechanism 100. A receiver 50 is provided on both sides of the frame section 30 in an exemplary embodiment. The two receivers 50 are coupled by first and second pivot members 45, 85 that pass through first and second pivot or hinge points 40, 80 respectively. First pivot member 45 is also coupled to the boot portion 30. Each receiver 50 has a spring member 55, a slot 60 for the first pivot member 45, and a notch 65 for the first pivot member 45. The receiving members 50 and the spring member 55 having an initial or starting position. The first pivot member 45 is disposed to slide within the slot 60 and engage the notch 65 from the initial position. Simultaneously, first pivot member 45 is also slideably disposed in a frame channel 70 in frame portion 30. This allows first pivot member 45 to slide in the channel 70 and down the slot 60 and into the notch 65 with first part of the rotation of boot portion 10. The receiver 50 is then carried back to the initial position with the further rotation of the boot portion 10 as the first pivot member 45 is held in the notch 65, as shown in FIG. 2A. This effectively wedges the pivot member in the notch 65, where it pins the system through only the motion of the vehicle.

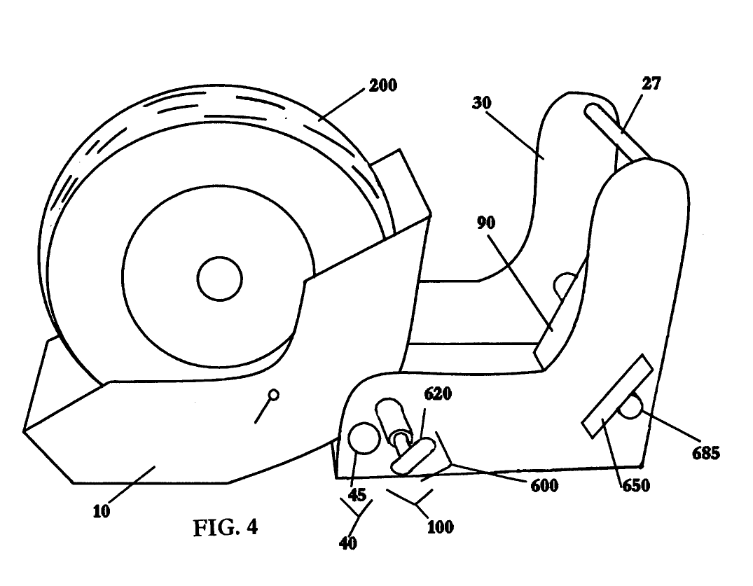

FIG. 2A shows a close up side view of the retainer portion of the locking mechanism in a closed position with the open position in shadow. The boot portion 10 receives a vehicle wheel 200. The tire is driven either manually or by the vehicles propulsion system into the boot portion 10. Once completely in the boot portion 10, the driving force, from the vehicle or imparted through the vehicle, begins to rotate the boot portion 10 about the hinge point 40. The first pivot member 45 fits in slot 60 of the frame portion 30 and frame channel 70 of the receiver 50. As the boot portion 10 is rotated about the hinge point 40 toward the frame portion 30, the first pivot member 45 portion is depressed along a slot 60 in the receiver 50 and into a notch 65 at the end of the slot 60 from an open position to a closed position. A locking mechanism can be utilized to secure the system. For example, a locking plate may be utilized, as further described in relation to FIG. 2B, or any of the alternative locking mechanism disclosed herein or known in the art may be utilized to secure the system, such as the locking pins of FIGS. 4-7.

FIG. 2B shows a close up side view of the retainer portion and the locking plate of the locking mechanism of an exemplary embodiment in a closed position with the open position in shadow. As the boot portion 10 completes its rotation into the frame portion 30, the first pivot member portion 45 in notch 65 is held in place by spring member 55. Simultaneously, as boot portion 10 is rotated into frame portion 30 the first pivot member 45, coupled to the boot portion 10, is drawn upwardly in relation to the frame in frame channel 70. As the first pivot member 45 rises in the frame channel 70 second hinge point 80 rotates. A locking plate 90 is disposed within the frame portion 30 below stop 27. The locking plate 90 is coupled to the second hinge point 80 through second pivot member 85. The locking plate 90 is initially in contact with the base of the frame portion 30 when the instant invention is in its open position, as shown in FIG. 1C. As the boot portion 10 first rotates about the first hinge point 40, the locking plate is not initially moved. As the boot portion 10 nears the closed position, fully entering the frame potion 30, the rotation of the second hinge pivot member 85 raises the locking plate 90 to a point slightly above the tip 12 of boot portion 10. In this position locking plate 90 prevents disengagement of boot portion 10 from the frame portion 30 and effectively locks the instant invention.

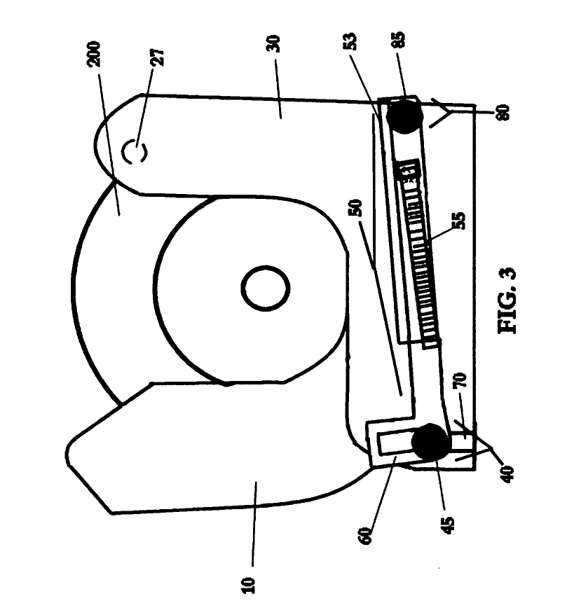

FIG. 3 shows a side view of an exemplary embodiment of the instant invention in a closed position. To release the instant invention from the closed position shown in FIG. 3, the receiver 50 has a release mechanism 53. In an exemplary embodiment this release mechanism 53 is a foot pedal extending from the receiver 50. The instant invention remains locked until receiver 50 is released, releasing spring member 55 and, thereby, releasing the first pivot member 45 from notch 65. The foot pedal release mechanism 53 pushes the first pivot member 45 to a position that allows it to pop out of the notch 65. Once released, the first pivot member is free to move down the slot 60 and stops at the base of channel 70 as the wheel 200 is rotated out of the invention. This returns the receiver 50 to its starting or opening position, further down on the frame portion 30. This downward movement relative to the frame portion 30 also rotates second pivot member 85 down and, in turn, moves the locking plate 90 back down to the floor of floor or base of the frame portion 30, this being the open or starting position of the locking plate 90. This permits boot portion 10 to be freely rotated back into an open position, as seen in FIG. 1C. Again, a driving force, either from the vehicle or thorough some external force on the vehicle, moves the vehicle away from the frame portion 30. The boot portion 10 with the wheel 200 held within it rotates about the first hinge point 40 to the open position.

FIG. 4 shows a further exemplary embodiment of the instant invention in an open position. The further exemplary embodiment utilizes a locking pin 600, here a spring-loaded, half twist locking pin, in place of the receiver 50 of the previous embodiments, as the locking mechanism 100. Although a single locking pin 600 is shown, any number of pins together with any combination of the previously disclosed elements of the locking mechanism 100 may be combined and utilized in the locking mechanism of the instant invention. Specifically, a locking pin 600 can also be combined with the receiver 50 of the previous embodiment to provide extra protection in keeping the device closed. In the exemplary embodiment shown in FIG. 4, the boot portion 10 again rotates into frame portion 30. Once rotation is complete, spring-loaded locking pin 600 is engaged with locking pin hole 610 by simply turning the operating member 620.

In this embodiment, locking plate 90 can also be provided with a spring-loaded pivot member 685. The spring loaded pivot member 685 keeping locking plate 90 in its closed position that is raised from the bottom of frame portion 30 as seen in FIG. 3B. This allows the tip 12 of boot portion 10 to pass the locking plate 90 and pushes the locking plate 90 back into its position with the tip 12 below locking plate 90, preventing the wheel 200 from rolling out of the closed position.

To release the embodiment of FIG. 4 from the closed position, spring-loaded locking pin 600 is turned and release member 650 is depressed pushing the locking plate down to its open position in contact with the base of frame section 30, as seen in FIG. 2B in shadow. The vehicle is then rolled out, as described in relation to the previous embodiments.

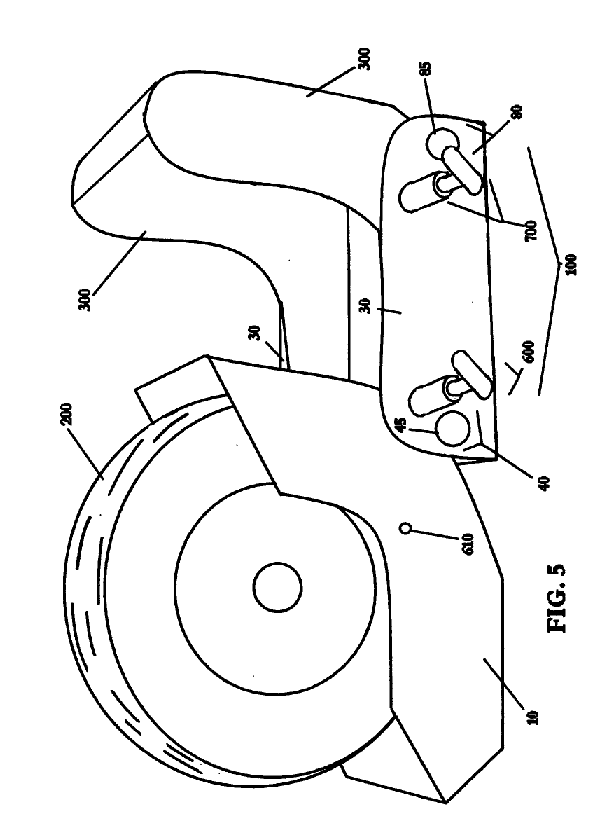

FIG. 5 shows a still further exemplary embodiment of the instant invention in an open position. In the still further exemplary embodiment shown locking mechanism 100 is again a locking pin 600 and again a spring-loaded pin. A second locking pin 700, depicted as a similarly spring loaded pin, engages a second locking pinhole (not shown) and restrains a second boot portion 300. The second boot portion 300 is coupled to the frame portion 30 by second hinge or pivot point 40 and second pivot member 85. The second boot portion 300, unlike the first boot portion 100 of the exemplary embodiment, has no enclosure portion on the side that engages with the frame portion 30. Instead, the second boot portion 300 hinges at hinge point 40 and is released by turning second locking pin 700. This opens the side of the device opposite the first boot portion 100 and allows the vehicle wheel 200 to alternatively be moved out of the instant invention in the same direction it entered, away from first boot portion 100. In an alternative exemplary embodiment, the second boot portion 300 is coupled to and moves with the first boot portion 30 from and open position. This can occur when the vehicle enters the system. This movement can be simultaneous or offset by specific timing requirements. The movement can be facilitated by any number of couplings, including, for example, but not limited to mechanical linkages, gearing devices, or similar systems. Either of the exemplary embodiments may also utilize any of the previously disclosed elements in its locking mechanism, in any combination.

In additional embodiments, the boot portion 10 with the wheel 200 can be moved atop a locking or trigger plate held within the frame portion 30. The locking plate can raises the receiver 50 while leaving the pivot member 45 in the notch. The pivot member is thus captured with spring member 55 in the notch 65 and locks the boot portion 10 in place, in a manner similar to that described above. The slot 60 and notch in the receiver 50 are repeated on both sides of the instant invention and the pivot member 45 is likewise retained. The receiver 50 is held under pressure from spring member 55 coupled to the receiver 50 in the notch 65. The pivot member 45 in combination with the receiver 50 and the spring member 55 keep the boot portion 30 retained. Additional restraints, such as additional pin-members or locking mechanisms, may be used to add additional safety and security in keeping the instant invention closed.

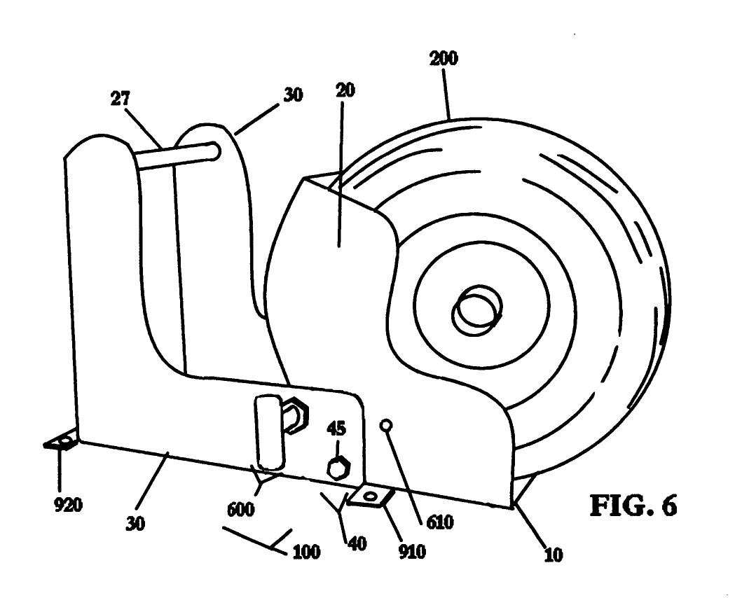

FIG. 6 shows a still further embodiment of the instant invention with a quick release plate, the instant invention in an open position. Again the embodiment shown has a boot section 10 rotatably coupled at hinge point 40 to frame portion 30 through hinge member 45. The locking mechanism 100 is shown again as a locking pin 600, here a spring-loaded pin, with locking pinhole 610. The exemplary embodiment of FIG. 6 adds a first and a second mounting plate 910, 920 respectively, that mate with mounting protrusions (not shown) to affix the embodiment to a surface.

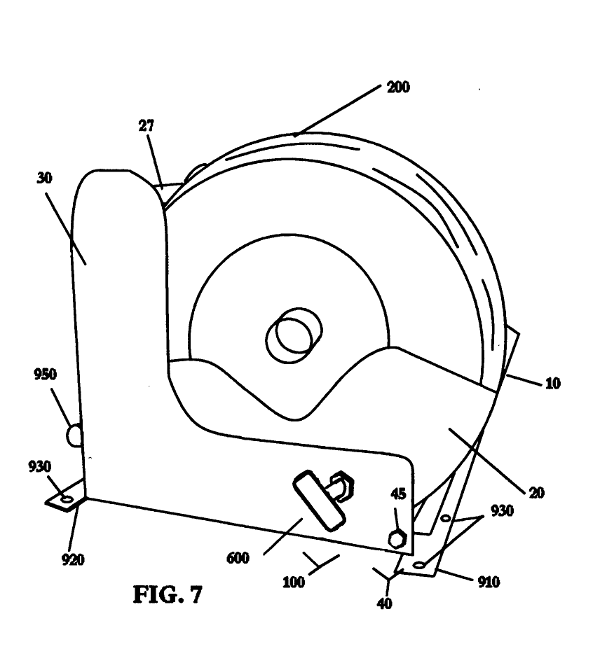

FIG. 7 shows a still further embodiment of the instant invention with a quick release plate, the instant invention in a closed position. The exemplary embodiment having first and second mounting plates or frame 910, 920 with mounting hardware through holes 930 to mount the embodiment to a surface. To facilitate quick release, a still further mounting-locking pin 950 is provided. This pin can function in a manner similar to the description of locking pin 600 above. The mounting locking pin 950 locks the embodiment into the first and second mounting plates 910, 920 through mounting protrusions (not show).

The invention is described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

1. A vehicle restraint system restraining a vehicle to a transport, comprising:
a first of an at least two body portions freely and rotatably coupled to a second portion of an at least two body portions and receiving a wheel of said vehicle, the second of the at least two body portions being coupled to said transport; and
a locking mechanism, wherein said first body portion of the at least two body portions is engaged by the wheel of the vehicle to be restrained, the motion of the vehicle rotating the first body portion into the second body portion engages the locking mechanism to securely restrain the vehicle to the transport.

2. The vehicle restraint of claim 1, further comprising an at least one pivot point with an at least one pivot member therethrough, rotatably coupling the first body portion and the second body portion.

3. The vehicle restraint of claim 2, wherein the at least one pivot point and the at least one pivot member further comprise a first and second pivot point and a first and second pivot member.

4. The vehicle restraint of claim 3, wherein the first pivot member is coupled to the second and first body portions at said first pivot point.

5. The vehicle restraint of claim 4, further comprising an at least one receiver portion wherein the engagement of the locking mechanism moves the at least one receiver portion relative to the second body portion.

6. The vehicle restraint of claim 5, wherein the at least one receiver is coupled by first and second pivot members that pass through first and second pivot points.

7. The vehicle restraint system of claim 6, wherein each receiver further comprises an at least one spring member, a slot with the first pivot member slideably disposed therein, and a notch extending from the slot and receiving the first pivot member where the pivot member is slidably disposed into the notch when the system is rotated to a closed position.

8. The vehicle restraint system of claim 7, wherein the first pivot member is simultaneously slideably disposed in a frame channel in a frame portion of the second body portion.

9. The vehicle restraint system of claim 8, wherein the first pivot member slides simultaneously in said slot and said frame channel and into the notch during an initial rotation of said second body portion.

10. The vehicle restraint system of claim 9, wherein the first pivot member is pushed into the notch when the locking mechanism is engaged in a closed position and the first pivot member is held in the notch by the at least one spring member.

11. The vehicle restraint system of claim 6, wherein as the first body member rotates into the second body member the second pivot member rotates at the second hinge point.

12. The vehicle restraint system of claim 11, further comprising a locking plate disposed within the second body portion, wherein the locking plate is coupled to the second pivot member and rotates therewith.

13. The vehicle restraint system of claim 12, wherein the locking plate is coupled to the second pivot member such that when the receiver is moved to the closed position the second pivot member rotates the locking plate up just above a lip of the first body portion.

14. The vehicle restraint of claim 8, further comprising an at least one release mechanism to release the vehicle restraint from the closed position.

15. The vehicle restraint of claim 14, wherein the at least one release mechanism engaging and disengaging an at least one spring member.

16. The vehicle restraint of claim 15, wherein the at least one receiver is moved from a first position, with the first pivot member in a first position, moving with the motion of the first body member that moves the first pivot member down the slot and to a second position to engage the first pivot member in the notch then back to the first position with the completion of the rotation of the first body portion, the first pivot member being held in the notch.

17. The vehicle restraint of claim 15, wherein the release mechanism is operated without requiring use of an operators hands.

18. The vehicle restraint of claim 17, wherein the release mechanism further comprises a step plate that is depressed and releases the spring member which in turn allows the at first pivot member to freely move within the slot and channel to an open position.

19. The vehicle restraint of claim 18, wherein the vehicle movement returns the system to an open position.

20. The vehicle restraint of claim 2, further comprising enclosure portions extending from the first portion and restraining the wheel.

21. The vehicle restraint system of claim 20, further comprising a first enclosure side and second enclosure side portions of the first body portion, extending up from a curved bottom portion, the bottom, first side and second side portions extending around the circumference of the wheel of the vehicle.

22. The vehicle restraint of claim 21, further comprising a third and fourth side enclosure portions extending from the second body portion, wherein the enclosure portions extends from the first portion to enclose between about 90 and about 270 degrees of the wheel when the first portion rotates into the second portion.

23. The vehicle restraint system of claim 21, wherein the enclosure portions extend around between about fifty and ninety percent of the circumference of the wheel when the system is closed.

24. The vehicle restraint of claim 23, wherein the enclosure portions and the first portion are semi-circular.

25. The vehicle restraint of claim 2, wherein the first and second portion are composed of at least one of steel, iron, aluminum, rubber, plastic, and composite.

26. The vehicle restraint of claim 2, wherein the locking mechanism is an at least one spring loaded pin that engages a corresponding detent in said second body portion.

27. The vehicle restraint of claim 26, wherein the at least one spring loaded pin is pulled to release the second body portion and remove the vehicle from the vehicle restraint system.

28. The vehicle restraint system of claim 3, further comprising a locking plate, the locking plate being coupled to the second pivot member such that when the first body portion is moved to the closed position the second pivot member rotates the locking plate up just above a lip of the first body portion.

29. The vehicle restraint system of claim 1, wherein first body portion further comprises a frame portion.

30. The vehicle restraint system of claim 29, wherein the frame portion further comprises an at least one mounting protrusion.

31. The vehicle restraint system of claim 30, further comprising a mounting frame, the mounting frame being connected to the transport and releasably engaging the at least one mounting protrusion of the frame portion.

32. The vehicle restraint system of claim 31, wherein said second body portion further comprises a frame portion and a second rotatable body portion.

33. The vehicle restraint system of claim 32, wherein said second rotatable body portion is rotatably coupled to the frame portion and rotates in an opposite direction to said first body portion.

34. The vehicle restraint system of claim 3, wherein the transport is one of a transport vehicle, a trailer, a dolly, or a cart.

35. A vehicle restraint system restraining a vehicle to a transport, comprising:
a frame portion coupled to the transport;
a first body portion rotatably coupled to and freely rotating with respect to the frame portion through the motion of the vehicle;
a second body portion rotatably coupled and freely rotating with respect to said frame portion through the motion of the vehicle;
a locking mechanism, wherein said first portion is engaged by the vehicle and the motion of the vehicle rotates the first and second body portion into said frame portion, the locking mechanism being engaged to lock the first and second body portion into place by the rotational motion imparted by the vehicle and secure the vehicle to the transport.

36. The vehicle restraint system of claim 35, wherein the first and second body portion are coupled at a common point of rotation to simultaneously transmit motion to both first and second body portions.

37. The vehicle restraint system of claim 36, wherein the first and second body portions are coupled by an at least one mechanical link to transmit simultaneous motion through both first and second body portions.

38. The vehicle restraint system of claim 37, wherein the first and second body portion are coupled by a geared coupling mechanism that simultaneously transmits the motion of the first body portion to the second body portion.

39. A method of restraining a wheeled vehicle on a transport, comprising the method steps of:
coupling a vehicle restraining system to said transport;
propelling said wheeled vehicle onto said transport;
guiding an at least one wheel of the wheeled vehicle into a first portion of a vehicle restraining system;
rotating the first portion of the vehicle restraining system into a second portion of the vehicle restraining system through the motion of the vehicle, the second portion being coupled to the transport; and
engaging a locking mechanism in the vehicle restraining system when the first portion of the vehicle restraining system is fully engaged with the second portion of the vehicle restraining system restraining the vehicle to the transport.

40. The vehicle restraint system of claim 1, wherein the system restrains a rated load under acceleration or deceleration of at least 0.2 g in at least one of a forward, rearward, lateral, and upward direction relative to the motion of travel of the vehicle and transport.

41. The vehicle restraint system of claim 40, wherein the system restrains a rated load under acceleration or deceleration of at least 0.5 g in at least one of a forward, rearward, lateral, and upward direction relative to the motion of travel of the vehicle and transport.

42. The vehicle restraint system of claim 41, wherein the system restrains a rated load under acceleration or deceleration of at least 0.8 g in at least one of a forward, rearward, lateral, and upward direction relative to the motion of travel of the vehicle and transport.

43. The vehicle restraint system of claim 42, wherein the rated load is at least 700 pounds.

45. The vehicle restraint system of claim 2, wherein the second body portion includes an at least one wheel stop, the at least one wheel stop engaging the wheel of the vehicle and aiding in securing the wheel when the system is closed and the lock mechanism engaged.

46. The vehicle restraint system of claim 45, wherein the position of the at least one wheel stop on the second body portion is adjustable.

47. The vehicle restraint system of claim 33, wherein the locking mechanism is an at least two spring loaded pins coupled to and selectively securing said first body portion and said second rotatable body portion in a closed position.

48. The vehicle restraint system of claim 1, wherein the at least two body portions comprise only the first and second body portions

49. The vehicle restraint system of claim 1, wherein the at least two body portions comprise three or more body portions.
